(19) United States
(12) Patent Application Publication
(10) Pub. No.: US 2008/0186723 A1
(43) Pub. Date: Aug. 7, 2008

(54) Two-sided light-passing device for the additional warning light of an automobile rear-view mirror

(76) Inventor: Chi-San Huang, Kaohsiung County (TW)

Correspondence Address: Chi-San HUANG, No. 24, Alley 53, Lane 2, Sec. 2,, Zhongshan Road, Hunei Shiang, Kaohsiung County, 829, omitted

(21) Appl. No.: 11/702,143

(22) Filed: Feb. 5, 2007

(51) Int. Cl. B60Q 1/50

(52) U.S. Cl. 362/494

(57) ABSTRACT

A two-sided light-passing device for the additional warning light of an automobile rear-view mirror includes a circuit board bored with plural light-passing holes at the locations respectively corresponding with the luminous bodies of LEDs. By so designing, light emitted by the luminous bodies of the LEDs can be transmitted to the rear side of the circuit board through the light-passing holes, and hence the bright light of the LEDs can be seen by the drivers of the automobiles coming from front and coming from behind. The two-sided light-passing structure for the additional warning light of an automobile rear-view mirror of this invention is provided with only one circuit board, able to economize producing cost.

### BACKGROUND OF THE INVENTION

1. Field of the Invention

This invention relates to a two-sided light-passing device for the additional warning light of an automobile rear-view mirror, particularly to one provided with only one circuit board, able to lower producing cost.

2. Description of the Prior Art

For the sake of insuring driving safety, an automobile usually has its rear-view mirror installed thereon with a warning light able to function together with the directional light synchronously. The warning light is assembled on the back side of the mirror shell to be seen only by the drivers of the automobiles coming from front, or assembled on the connecting arm that connects the mirror shell and the automobile body for giving out light through the front and the rear side of the connecting arm, so that the drivers of the automobiles coming from front and from behind can see the shining warning light. The warning lamp able to give out light through the opposite sides of the connecting arm, as shown in FIG. 1, includes a connecting arm 30 between the mirror shell 10 and the fixing base 20 of an automobile. The connecting arm 30 has its intermediate portion bored with a through hole 31 installed therein with a warning light 40 able to function together with the directional light synchronously, as shown in FIG. 1. Such a warning light 40, as shown in FIGS. 2 and 3, includes two circuit boards 41, two transparent covers 42 and two bolts 43.

The two circuit boards 41 have their backs closely resting against each other and their outward sides respectively disposed with plural LEDs 410, and each circuit board 41 has its opposite ends respectively bored with an insert hole 411.

The two transparent covers 42 are respectively covered on the outward sides of the two circuit boards 41 and have their inner opposite ends respectively and correspondingly provided with a slotted stud 420 extending outward vertically.

The two bolts 43 are respectively inserted through the slotted studs 420 of the two transparent covers 42 and the insert holes 411 of the two circuit boards 41 to fix the two circuit boards 41 between the two transparent covers 42. Then, the two transparent covers 42 are respectively stuck on the opposite edges 32 of the through hole 31 of the connecting arm 30 and firmly positioned in the through hole 31.

However, in order to give out light through the opposite sides of the connecting arm 30, the conventional warning light 40 is provided with two circuit boards 41 respectively installed thereon with LEDs 410, thus increasing producing cost.

### SUMMARY OF THE INVENTION

The objective of this invention is to offer a two-sided light-passing device for the warning light of an automobile rear-view mirror, which is provided with only one circuit board, able to lower producing cost.

### BRIEF DESCRIPTION OF DRAWINGS

This invention will be better understood by referring to the accompanying drawings, wherein:

FIG. 1 is a front view of a conventional automobile rear-view mirror;

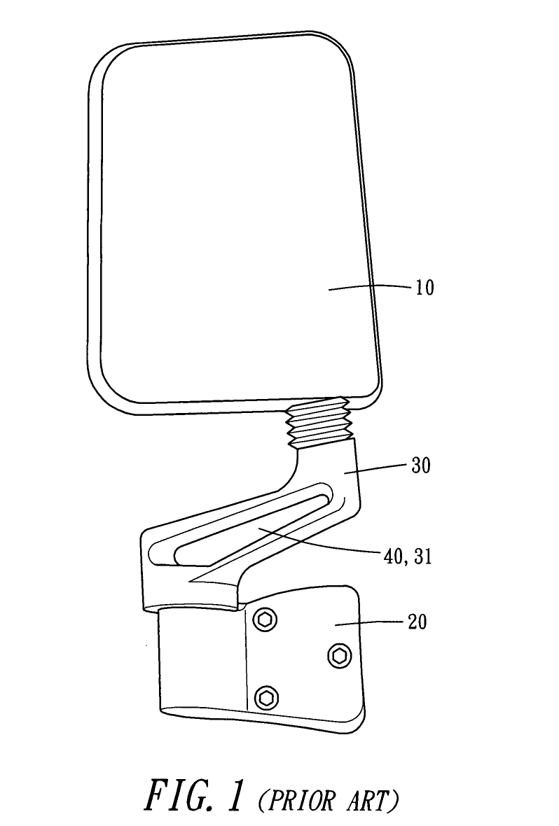

FIG. 2 is an exploded perspective view of a two-sided light-passing structure of the conventional automobile rear-view mirror;

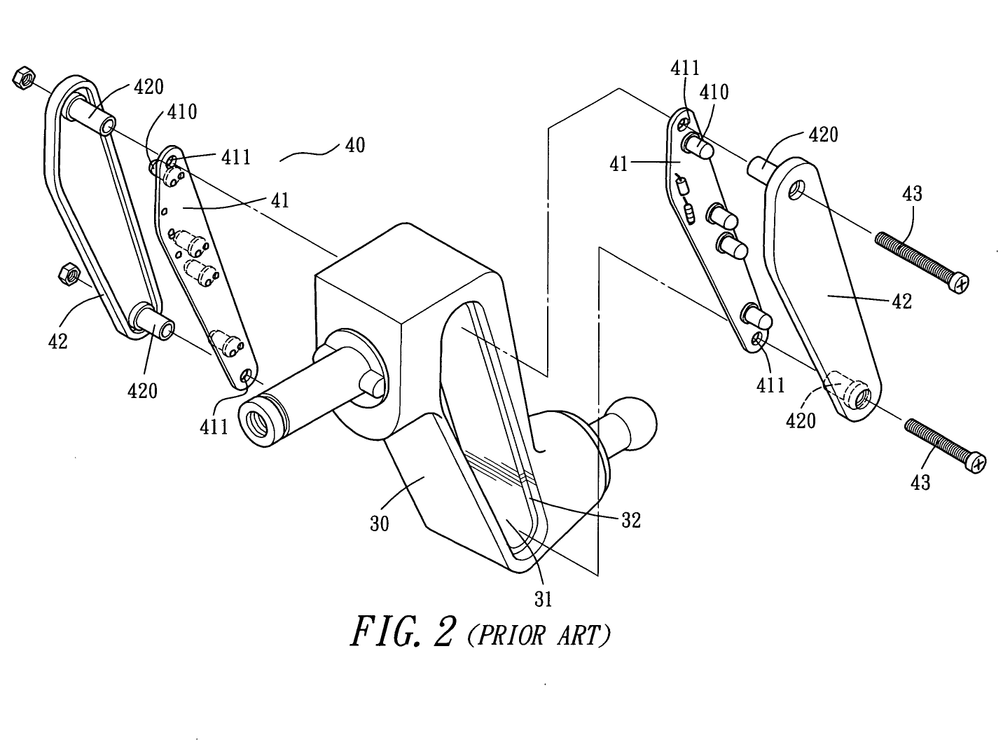

FIG. 3 a cross-sectional view of the two-sided light-passing structure of the conventional automobile rear-view mirror;

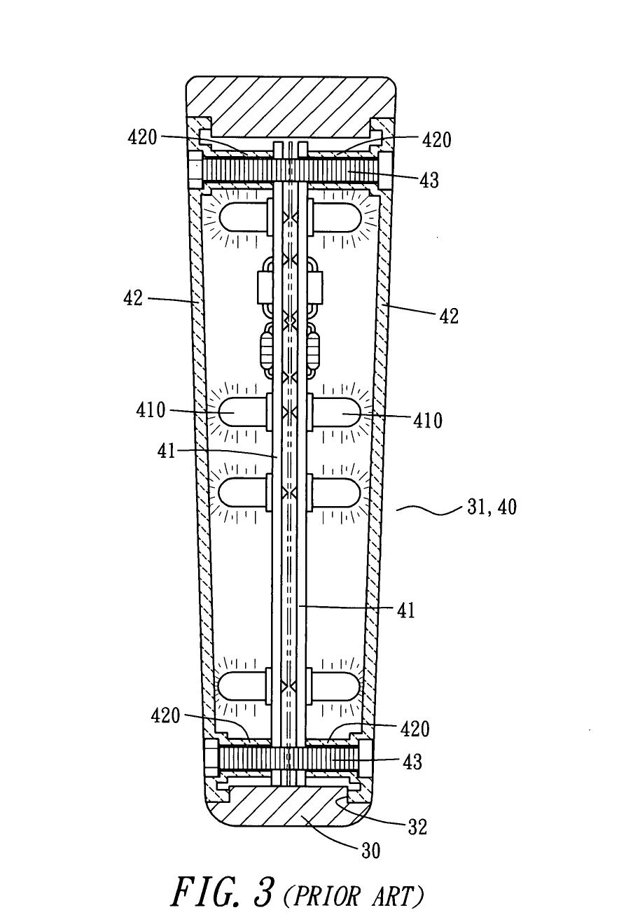

FIG. 4 is an exploded perspective view of a first preferred embodiment of a two-sided light-passing device for the additional warning light of an automobile rear-view mirror in the present invention;

FIG. 5 is a cross-sectional view of the first preferred embodiment of the two-sided light-passing device for the additional warning light of an automobile rear-view mirror in the present invention;

FIG. 6 is a cross-sectional view of a second preferred embodiment of a two-sided light-passing device for the additional warning light of an automobile rear-view mirror in the present invention;

FIG. 7 is an exploded perspective view of a third preferred embodiment of a two-sided light-passing device for the additional warning light of an automobile rear-view mirror in the present invention; and

FIG. 8 is a cross-sectional view of the third preferred embodiment of the two-sided light-passing device for the additional warning light of an automobile rear-view mirror in the present invention.

### DETAILED DESCRIPTION OF THE PREFERRED EMBODIMENT

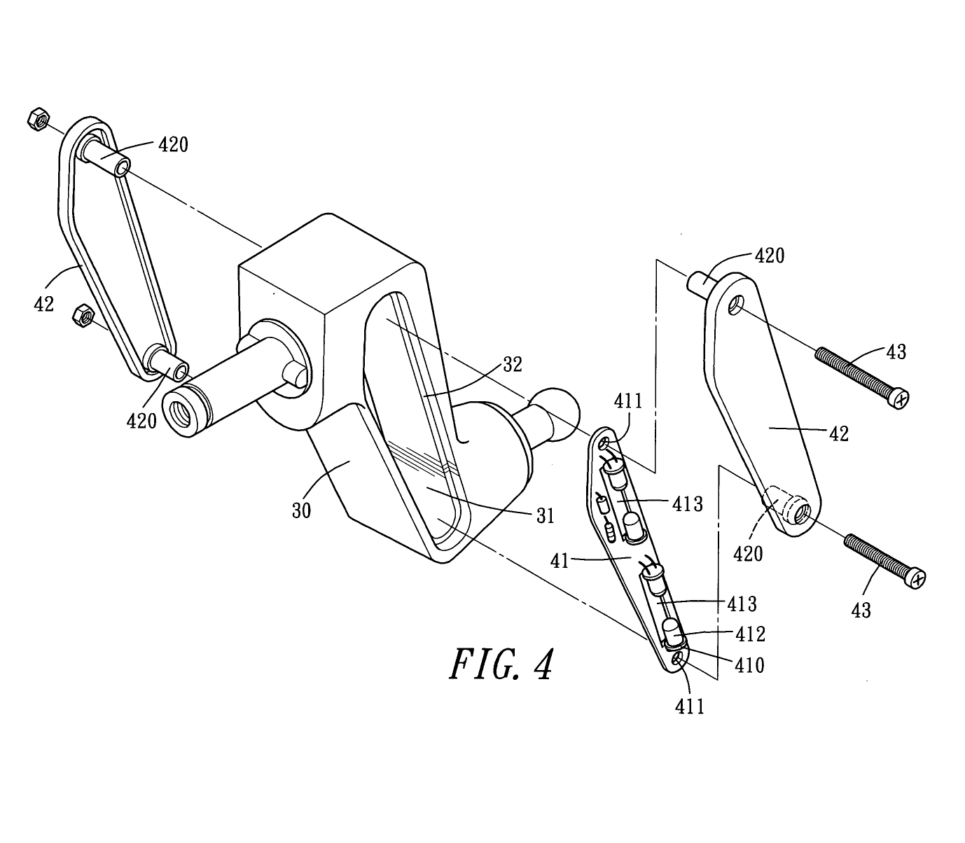

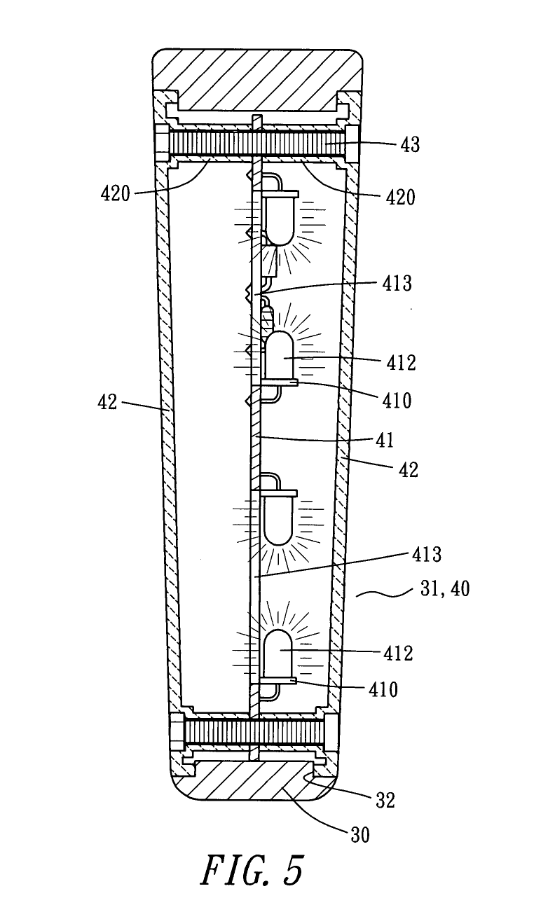

A first preferred embodiment of a two-sided light-passing device for an additional warning light of an automobile rear-view mirror in the present invention, as shown in FIGS. 4 and 5, is to fix a warning light 40 in the through hole 31 of the connecting arm 30 that connects the mirror shell and the automobile body. The warning light 40 is composed of only one circuit board 41, two transparent covers 42 and two bolts 43.

The circuit board 41 is installed thereon with plural LEDs 410, whose luminous bodies 412 are disposed in parallel with the circuit board 41. The circuit board 41 is bored with plural light-passing holes 413 at the locations respectively corresponding with the luminous bodies 412 of the LEDs 410 so that light emitted by the luminous bodies 412 can be transmitted to the rear side of the circuit board 41 through the light-passing holes 413. Thus, the light of the luminous bodies 412 of the LEDs 410 can be seen from both the front and the rear side of the circuit board 41, unnecessary to install a second circuit board 41 and thus lowering producing cost.

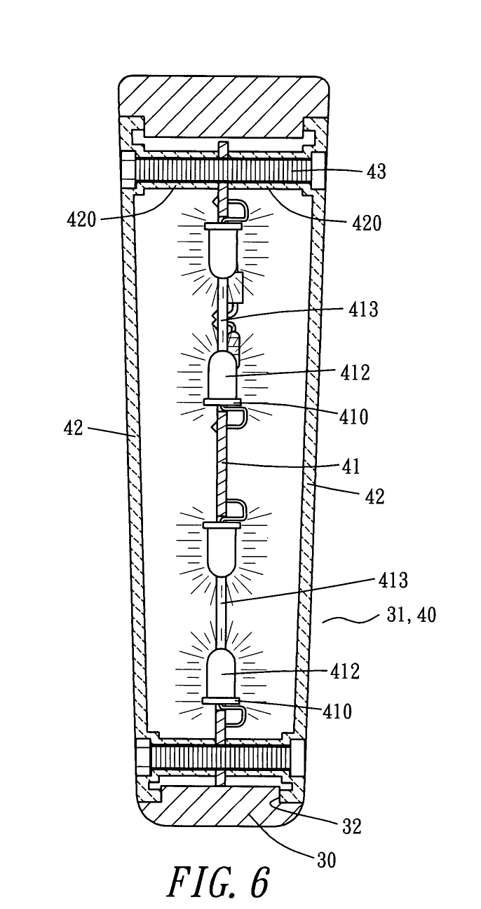

A second preferred embodiment of a two-sided light-passing device for the additional warning light of an automobile rear-view mirror in the present invention, as shown in FIG. 6, is to have the luminous bodies 412 of the LEDs 410 respectively disposed inside the light-passing holes 413 and arranged in alignment with the circuit board 41. Thus, with the central axis of the luminous body 412 acting as a datum line, one half portion of the luminous body 412 is exposed to the front side of the circuit board 412 and the other half portion is exposed to the rear side of the circuit board 41, as shown in FIG. 6.

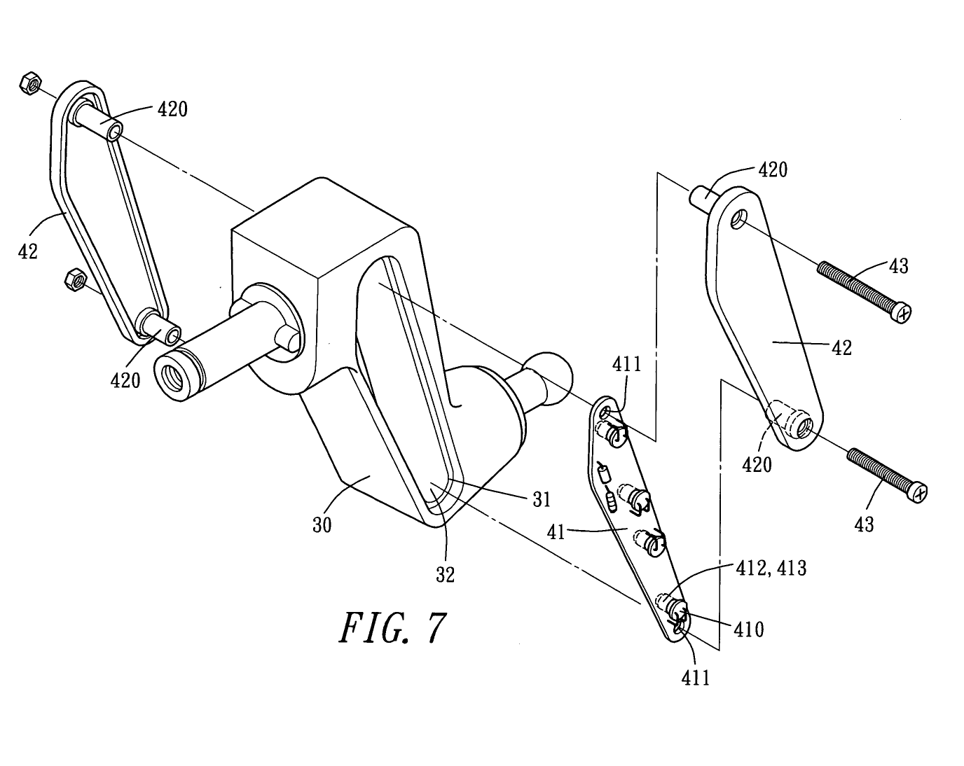

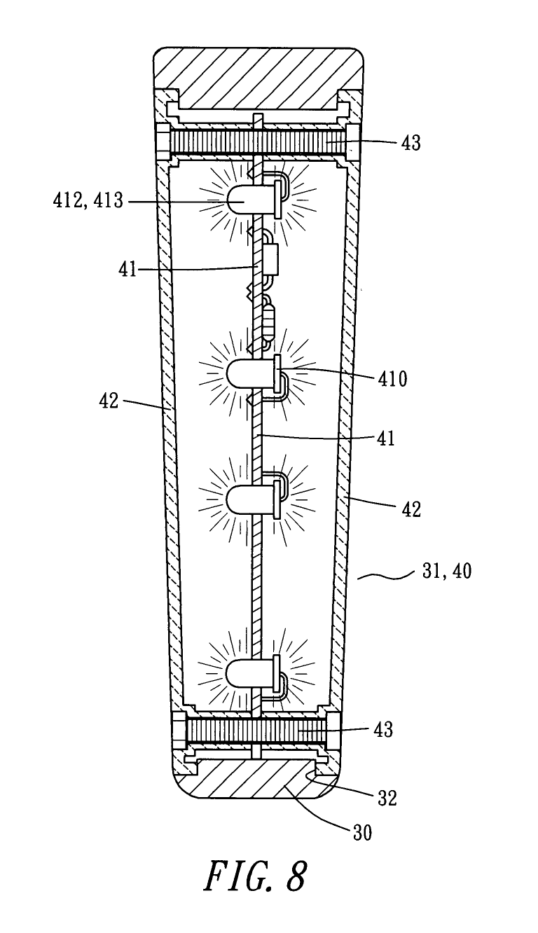

A third preferred embodiment of a two-sided light-passing device for the additional warning light of an automobile rear-view mirror in the present invention, as shown in FIGS. 7 and 8, is to have the luminous body 412 of the LEDs 410 transversely inserted in the light-passing hole 413 of the circuit board 41 (the light-passing hole 413 formed with an inner diameter as large as the outer diameter of the luminous body 412), letting the luminous bodies 412 of the LEDs 410 disposed perpendicular to and crossing with the circuit board 41, and the front and the rear half portion of each luminous body 412 of the LED 40 respectively positioned on the front and the rear side of the circuit board 41. Thus, the bright light given out by the luminous bodies 412 of the LEDs 410 can be seen from both the front and the rear side of the circuit board 41. By so designing, when the LEDs 410 together with the directional light give out light synchronously, the warning light will shine at its opposite sides at the connecting arm 30, and the light of the LEDs 410 can be seen by the drivers of automobiles coming from front and from behind, enabling the drivers of other automobiles understand the moving conditions of the automobile.

Although provided with only one circuit board 41, yet the warning light 40 of this invention can give out light to both the front side and the rear side of an automobile, insuring driving safety and able to lower producing cost.

While the preferred embodiments of the invention have been described above, it will be recognized and understood that various modifications may be made therein and the appended claims are intended to cover all such modifications that may fall within the spirit and scope of the invention.

I claim:

1. A two-sided light-passing device for the additional warning light of an automobile rear-view mirror, said device comprising a circuit board, two transparent covers and two bolts, said circuit board installed thereon with plural LEDs, said two transparent covers respectively covered on the opposite sides of said circuit board, said two bolts fixing said circuit board and said two transparent covers on an automobile rear-view mirror: and,
Characterized by said circuit board bored with plural light-passing holes at the locations respectively corresponding with the luminous bodies of said LEDs, light emitted by said luminous bodies of said LEDs transmitted through said light-passing holes, said light of said LEDs able to be seen from both the front and the rear side of said circuit board.

2. The two-sided light-passing device for the additional warning light of an automobile rear-view mirror as claimed in claim 1, wherein said luminous bodies of said LEDs are arranged in parallel with said circuit board and respectively positioned at a corresponding location of said light-passing hole of said circuit board.

3. The two-sided light-passing device for the additional warning light of an automobile rear-view mirror as claimed in claim 1, wherein said luminous bodies of said LEDs are respectively disposed in said light-passing holes of said circuit board and arranged in alignment with said circuit board, said luminous body, with its central axis serving as a datum line, having its front and rear half portion respectively exposed to the front and the rear side of said circuit board.

4. The two-sided light-passing device for the additional warning light of an automobile rear-view mirror as claimed in claim 1, wherein said luminous body of said LED is transversely inserted in said light-passing hole of said circuit board, each said luminous body of said LED having its opposite ends respectively extending out of the front and the rear side of said circuit board, each said luminous body of said LED positioned perpendicular to and crossing with said circuit board.
